(19) United States
(12) Patent Application Publication
(10) Pub. No.: US 2002/0095298 A1
(43) Pub. Date: Jul. 18, 2002

(54) Blind Gift Method and System

(75) Inventor: Christopher Ewing, Sacramento, CA (US)

Correspondence Address: Peter, Trzyna, P.O. Box 7131, Chicago, IL, 60680, US, Pktlaw@aol.com, (312) 240-0824

(73) Assignee: FrogMagic, Inc., Boulder (US)

(21) Appl. No.: 09/295,230

(22) Filed: Apr. 19, 1999

(51) Int. Cl. G06F 17/60

(52) U.S. Cl. 705/1

(57) ABSTRACT

### Abstract of Disclosure

This is a method and system whereby parties who know each other only by pseudonyms, such as by Internet e-mail addresses, may send and receive gifts while maintaining anonymity behind their pseudonyms. Steps of the method include receiving a request from a first pseudonymous party to take an order for a gift to be sent to a second party; obtaining from the first party an identification of the intended gift, and the pseudonym of the second party; and, looking up a non-pseudonymous name and address associated with the second in a database. Alternatively, the second party may be contacted and asked to confidentially reveal his or her name and mailing address for gift delivery purposes. While the second party's information is kept confidential from the first party, the second party has various choices including accepting the gift, accepting it upon certain conditions, or refusing it. The system of the invention includes components for permitting the first party to enter the second party's pseudonym; for determining the second party's true name and mailing address from his or her pseudonym; and, for sending the gift to the second party's true name and mailing address.

### Background of Invention

1.Field Of The Invention

The present invention relates generally to methods and systems for carrying out sales transactions, and more specifically to methods and systems for taking and filling orders for gifts.

2.Description Of The Related Art

When a person desires to send another a gift such as candy or flowers, there are established industries and networks in place for carrying out the request. Examples include FTD Florists, and the well-known Candygram. Normally, all gift vendors require is the name and address of the intended recipient, and the sender's payment for the gift. However, sometimes the name of the intended recipient is not known to the sender. Or, the full name or true name might not be known. This could be the case, for example, if a person enters a lace of business, and meets and is smitten by another who works there. Or, in a social setting, an introduction might include only a first name, or only a surname. In those cases, gift delivery could still be effected by directing the gift to the location where the intended recipient may be found; e.g. at the business where the meeting took place, or at a location mentioned by the intended recipient, where he or she is regularly present.

Despite the convenience to the gift-giver in being able to have a gift successfully delivered without having full name and personal address information, the intended recipient might not desire such attention from someone who is likely a mere acquaintance, at best. This is one potential draw-back to conventional gift services. Those interacting with members of the public in the workplace, or casually meeting strangers in social situations, are subject to being sent unwelcome gifts.

Sometimes, the full name of an intended recipient is known, but no address or delivery-location information is available. Such situations arise fairly frequently out of social functions. Conventional gift-delivery services cannot normally make a delivery in that case, i.e., based on a name, alone. So, absent some further research or word-of-mouth inquiry by the gift-giver, gift delivery will be impossible through conventional services. In contrast to the intended recipient who might shun a gift, others might be disappointed if they knew that a new acquaintance had such generous intentions, without any way to carry them out. So, conventional gift services have this drawback, as well.

People who interact with others over the Internet and the World Wide Web normally use pseudonym as a screen name or handle which essentially allows them to remain unidentified while they chat on-line, send instant messages, or send e-mail. And, participants in such interactions are now even able to exchange photographs, voice messages and video clips, as well as engage in real-time audio and videophone conversations. All of this can be accomplished while maintaining a pseudonym as one's primary identity, and while essentially preserving anonymity. Despite this screen of pseudononymity (or, perhaps, because of it) friendships and relationships, there is presently no way to send a gift to another person unless the prospective recipient is willing to reveal his or her true name and address. This need is neither addressed by conventional gift-delivery services, nor by current means of electronic commerce.

Thus, it appears that there is a heretofore unarticulated need for some medium through which people may get to know each other without initially revealing personal information, such as their true name and address information, wherein one person is able to send a physical gift to another. And, it would also be advantageous if the intended gift recipient were able to control the conditions under which gifts might be offered.

### Summary of Invention

The blind gift method and system of the present invention are adapted to overcome the above-noted shortcomings and to fulfill the stated needs. The method comprises the steps of receiving a request from a first party to take an order for a gift to be sent to a second party known only by a pseudonym; obtaining from the first party the identification of the intended gift to be sent, and a pseudonym of the second party; and, looking up a non-pseudonymous name and address associated with the second party's pseudonym in a database. Further steps and features compatible with the inventive method effect the actual delivery of the gift, and provide flexibility and security to the method's users/ The system of the invention comprises means for a first party to identify one's self, a gift, and a pseudonymous second party; and, means for storing that information. Then, in combination herewith, the system comprises means for determining the second party's true name and mailing address from the pseudonym; and, means for sending the gift to the second party in his or her true name and mailing address.

While conventional gift-delivery systems may be functional even when the intended recipient is anonymous or pseudonymous, and while they may be non-functional if the sender lacks certain, key address-delivery information, the method of the present invention, and especially the Internet-based method, avoids the drawbacks that can result from those two situations. And, it yields many heretofore unavailable benefits, as well.

It is an object of the present invention to provide a method for sending a gift to a person who is known only be a pseudonym.

Yet another object of this invention is to provide a method for a person sending a gift to choose whether to remain anonymous; to identify himself or herself with a pseudonym; or, to identify himself or herself with partial or complete true-identity information.

It is a further object of the present invention to provide a method for a pseudonymously-known person offered a gift to choose conditions under which the gift will be accepted.

Yet a further object of the present invention is to provide a method for anonymous or pseudonymous gift-giving which is able to be practiced between members of a network wherein true name and address information of all members is kept in a database along with members' pseudonyms.

Still a further object of the present invention is to provide a method for anonymous or pseudonymous gift-exchange between a member of a network and an anonymous or pseudonymous party outside the network, wherein the network-members are all fully-identifiable by the network.

Another object of the present invention is to provide a method for anonymous or pseudonymous gift-giving between parties in a network, or between networks, where no database of the true name and address information is kept or available.

Still further objects of the inventive on-line blind gift method disclosed herein will be apparent from the drawings and following detailed description thereof.

### Brief Description of Drawings

FIG. 1 is a general schematic block diagram illustrating an embodiment of the inventive system carried out entirely within a member-network.

FIG. 2 is a general schematic block diagram illustrating an embodiment of the inventive system similar to that of FIG. 1, wherein outside vendors are employed.

FIG. 3 is a general schematic block diagram illustrating an embodiment of the inventive system carried out through a central Web site.

FIG. 4 is a general schematic block diagram illustrating an embodiment of the inventive system similar to that of FIG. 3, wherein the Giftor contacts vendors directly through vendors' Web sites.

FIG. 5 is a flow chart generally showing the steps of carrying out the inventive method as it might be practiced within the embodiment of the system illustrated in FIG. 2.

### Detailed Description

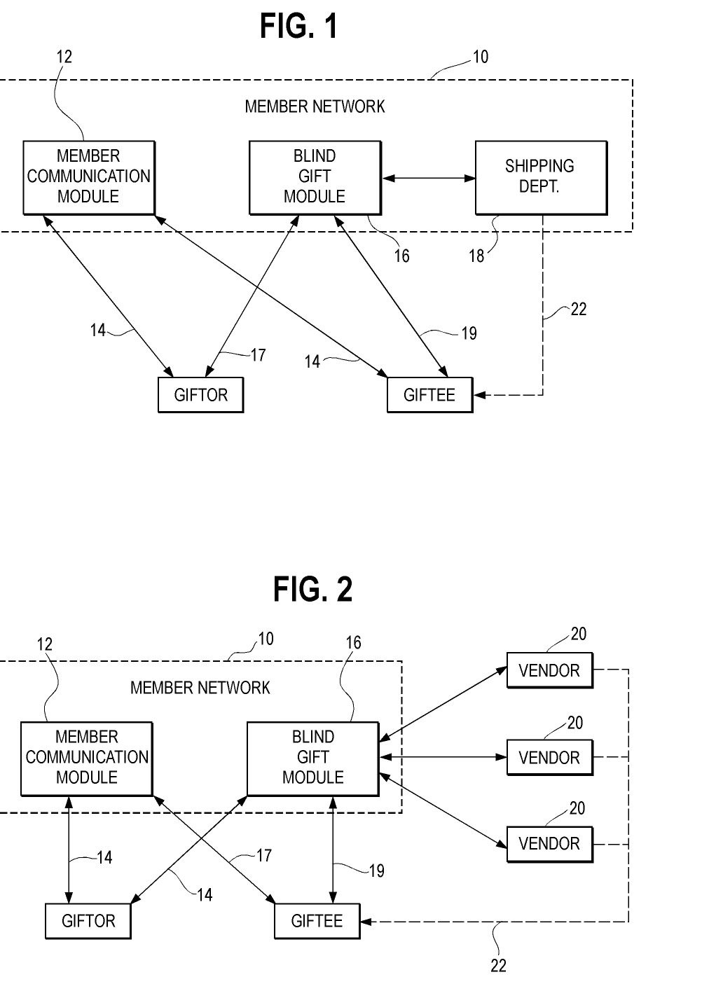

Referring now specifically to the drawings, FIG. 1 shows a flow chart of the inventive method as it might be carried out over a modem within an on-line membership computer network 10 such as America Online (AOL), wherein all members identify themselves by one or more pseudonyms, and wherein the member-network management keeps a database of true, full name and mailing address information associated with each pseudonym of each member.

Direct communication between members within the network takes place through a communication module 12, such communication therethrough being identified with reference numeral 14.

In preparation for carrying out the method, the member-network management provides new members, upon sign-up, with a series of choices relating to a blind gift program. First, the new member is asked to check boxes or otherwise make choices to indicate, without limitation: whether gifts will ever be accepted from any anonymous or pseudonymous party; whether gifts will be accepted only from anonymous or pseudonymous parties who are members of the member-network; whether gifts will be accepted only from parties who identify themselves with true name and address information; whether gifts ill be accepted from certain parties (listed by pseudonym or true name); whether gifts will be accepted only if they fall within certain parties (listed by pseudonym or true name); whether gifts will be accepted only if they fall within certain categories (e.g. only candy and flowers, but no lingerie); whether gifts costing more than a particular amount will be accepted; whether gifts should be delivered to the member's billing address, or to another address; and/or, whether certain categories of gifts will only be accepted from parties who identify themselves with true name and address information.

Another level of inquiry might seek directions from the member as to how gift attempts from other members that do not meet one or more of the chosen criteria should be handled. Choices might be sought for at least the three following possible categories including, without limitation: (1) whether to send a response to the member who attempted to send the gift; (2) whether to permit the member who attempted to send the gift to change the gift, or to change the member-identify information, and to try again; and/or, (3) whether to place the member who attempted the gift on a list of person prohibited from sending further gifts to the member.

Yet further, another series of initial set-up inquiries might seek choices from the member regarding how to deal with gifts the member sends which get rejected by an intended gift recipient. Examples include: in the instance where the gift is rejected based on the intended recipient's pre-set profile, whether to let the intend recipient know that a gift attempt was made; and, in the same instance, whether to let the intended recipient know certain identity information about the gift-sending member.

Yet another level of inquiry might seek directions on how to respond in the case of successfully-completed blind gift delivery transactions. Options might include thank-you responses; return gifts; transmission of the member's true, full name and address information; or, the like.

As further explained below, in alternative embodiments of the method many of the foregoing parameters able to be set up in a member's initial profile may alternatively be subjects of choice later on in a blind gift transaction. Thus, to provide for that, a new member may simply make a choice to be notified each time a blind gift attempt is made, and to be notified each time a gift is sent by the member is rejected; and, to be presented at that time with all of the choices for acceptance and/or response at that time.

Initial profile information might also be sought from the new member regarding certain aspects of gift-giving. For example, choice could be provided for different methods of payment, including payment by credit card on a per-transaction basis; monthly billing through the account set up for monthly membership dues; a separate account linked to a credit card just for gift-giving purposes; or, the like. A great amount of flexibility exists in this part of the method, and more options become available nearly every month as electronic commerce becomes better developed, and more and more commonplace. Now, programs referred to as electronic wallets which function as a debit account and include all of the information necessary for the wallet owner to carry out a purchase or other transaction, are known. Such devices would certainly be functional and useful in the context of the inventive method.

Other initial gift-sending profile information might include limitations on purchase amounts, or category limitations such as: no alcohol or tobacco; or, candy and flowers, only. This way, parental control may be exercised, and members who remain worries that an unauthorized user may access the account may limit the amount spent and the types of goods purchased as gifts.

The responses to these initial blind gift profile inquiries may become part of the new member's overall member profile. The new member, having the ability to set up several pseudonyms (commonly referred to as screen names or handles) may have a choice whether to have his or her blind gift profile apply to one, several, or all pseudonyms. And, as with other aspects of members' profiles within member-networks, existing members may change their profiles, at will.

The member-network will provide access to an internal, on-line blind gift software program accessible by anyone who wants to send a gift to another member. This will include an initial greeting screen, followed by requests for information about the sender; the intended gift; the intended recipient; and, the manner in which the gift-giving member wants the gift presented to the intended recipient.

For example, if a member encounters another member though on-line text, audio or voice chat; instant messaging; or, e-mail, and the member desires to send the other member a gift, the prospective gift-giving member may simply make an on-screen choice to use the blind gift function. This constitutes a request to send a blind gift. The request may be made by clicking on a link, for example.

Upon accessing the blind gift software module 6 within the member network, the gift-giving member (the Giftor) will either be automatically recognized by his or her pseudonym, or asked to enter a pseudonym. This causes the blind gift program to access the Giftor's gift-giving profile, if any, regarding method of payment, or any price, product-type or subject matter limitations.

(Communication between the Giftor and the blind gift module 16 is identified with reference numeral 17.)Then, the Giftor is given the opportunity to select the gift he or she desires to send. Choice of the gift may be made from a limited list selected and managed by the member-network management. Or, it may comprise an elaborate shopping program wherein a great number of vendors describe and graphically display a wide variety of gifts able to be sent to member-recipients in accordance with the methods herein. The desired gift or gifts may be identified and chosen by checking a check box, clicking an on-screen button, or the like. These functions are now becoming well-known and commonly used in on-line shopping. The user browses the wares, and as he or she makes product choices, they are sequestered in a shopping cart for including in a single, final purchase transaction at the end of the browsing/shopping session.

Once the blind gift program obtains a gift choice or choices from the Giftor, the intended recipient member (the Giftee) will need to be identified. As this embodiment of the method is being carried out within a membership network which keeps full, true name and address information associated with all members' pseudonyms in a database, all that is necessary is entry of the Giftee's pseudonym. Entry of the Giftee's pseudonym initiates a search function in the network database-access software, whereby the pseudonym is located; the full, true name and mailing address information associated herewith is identifies; and, then that name and address information is copied into name and address information fields in the delivery routine of the blind gift program software.

The gift choice and Giftee's pseudonym are all that is needed from the Giftor to process and deliver the gift order. However, the program may offer additional options to the Giftor at this point. For example, the Giftor may be able to choose whether or not the Giftee will be permitted to check on the price, subject matter and/or exact nature of the gift before accepting it. Or, the Giftor may have the option of remaining anonymous. Of course, choosing any of these options may affect whether the Giftee accepts the gift, or it may trigger actions dictated by choices the Giftee made in setting up his or her member profile.

Thus, before performing the final step, i.e., issuing a shipping order, the program checks the Giftee's profile information to see whether pre-set parameters will control the screening, acceptance and response; or, whether the Giftee has directed that it be handled on an ad hoc basis each time a gift attempt is made. If the gift attempt is rejected, based either on the Giftee's pre-set profile criteria or on an ad hoc response, the Giftor will receive a notification of that occurrence via the blind gift program software. (Communication between the blind gift module 16 and the Giftee is identified with the reference numeral 19.) Further explanation as to the reason(s) for rejection may be added, if the Giftee so desires. In the Giftee's profile, default Reponses for different bases of rejection may have been chosen (e.g., too personal; too expensive; will not accept anonymous gifts; etc.), or the Giftee may have drafted his or her own personalized messages; e.g., that's naughty; I don't accept candy forms strangers; etc. Alternatively, of course, the response may be drafted ad hoc by the Giftee.

At the point of gift rejection, there is an option to charge the Giftor a service fee for attempted use of the blind gift program. This is obviously a matter which will affect good will. But, there are certainly costs associated with administering the program, even upon a failed attempt, so a charge is not unreasonable. Indeed, even when a gift is rejected, the entire functionality of the program has been utilized, short of the single final step of issuing an order to a vendor. Thus, offset of that cost is warranted. A flat-rate fee covering the average per-use costs, might be reasonable; and, if desired, profit might be built in, as well. Of course, if the membership-network management chooses to operate this way, i.e. offsetting its costs out of the pockets of rebuffed Giftors,, prospective Giftors should be made aware of this at an early stage in the program, to preserve good will. It could be said that, in this day and age, the warding caveat emptor may extend to knowing your intended pseudonymous gift recipient well enough to avoid a service charge for a failed gift attempt!Other methods of generating revenue from the blind gift program which may be more palatable to the Giftor and management, alike, might include any number of types of advertising schemes. Advertisers of gift-type goods, and possibly services, as well, will likely pay for the opportunity to advertise their wares on the gift-selection screens of the blind gift program.

Further, the inventive program provides many opportunities to profit on a per-transaction basis, such as where a flat dollar amount or a percentage of the transaction amount is paid by the vendor for each transaction consummated.

If the gift is not rejected by the Giftee, either by his or her pre-established gift-receiving profile or by an ad hoc response, then an instruction is issued by the blind gift program software to initiate shipping the selected gift. This shipping instruction may be sent to a companion software module and cooperating shipping department 18 operating within the member network as shown in FIG> 1, or it may be sent to an outside vendor 20, as shown in FIG. 2. In either case, the shipping instruction would necessarily include the gift selection(s) and the full, true name and mailing address of the Giftee.

At this point, the portion of the transaction dealing with the charge for the merchandise might also be carried out. Of course, as in any purchase transaction, this charge will vary, relative to the value of the gift chosen. A great variety of existing software programs is available to carry out this step, which might comprise charging the Giftor's credit card or debit account; or. adding the charge to an open account. If the shipping instruction is sent to an outside vendor, the merchandise charge to the Giftor may be carried out within the network, with a confirmation to the vendor along with the shipping instruction; or, alternatively, the vendor may charge the Giftor directly.

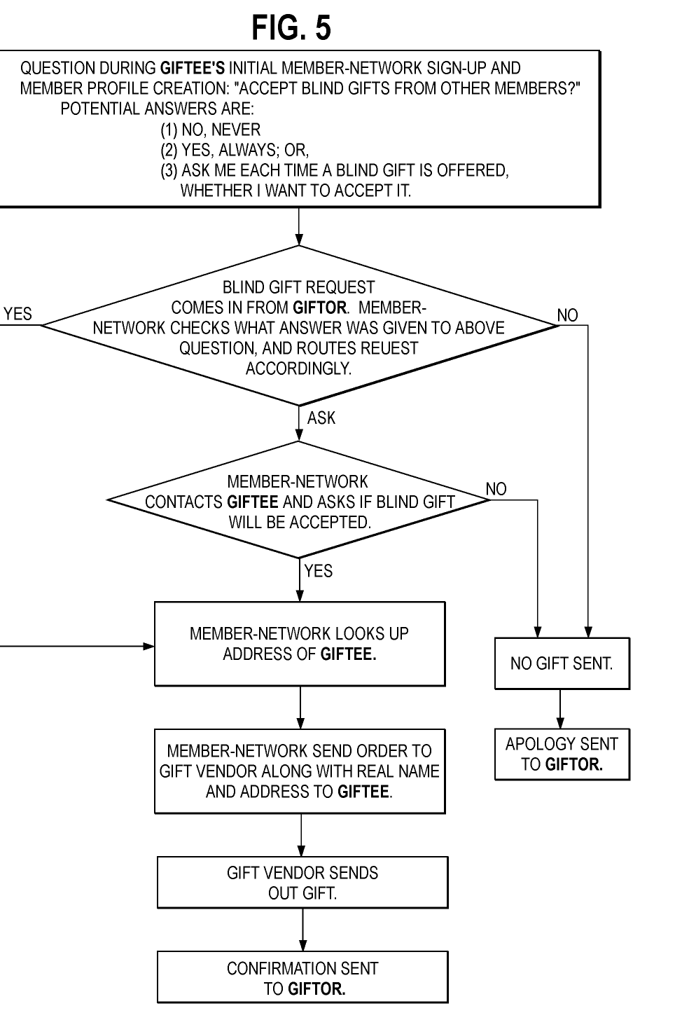

The physical step of shipping the chosen gift merchandise may be carried out by a department 18 within, or associated with, the member-network 10. This type of system is illustrated in FIG. 1. The step of shipping the merchandise is identified herein and in the drawing figures with reference numeral 22. In this first embodiment, the member-network is essentially the retailer. Alternatively, and likely more practical, is a system shipping instructions, and confirmation that the Giftor's account has been charged. This first alternative type of system is illustrated in FIG. 2. And, the flow chart of FIG. 5 generally shows the steps of carrying out the inventive method as it might be practiced within this second embodiment of the system.

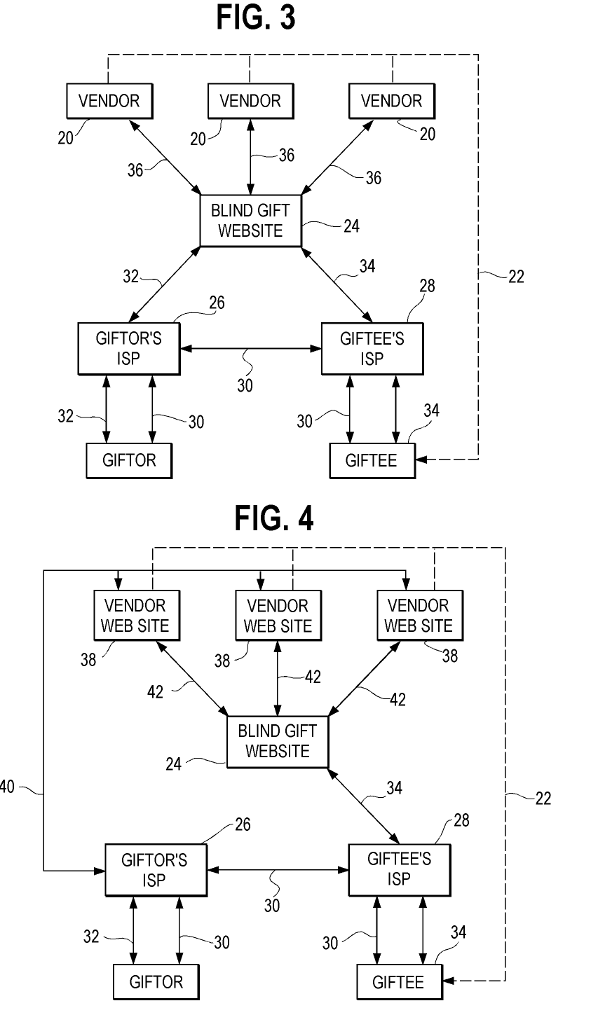

In yet a third alternative embodiment of the inventive method, shown in FIG. 3, members within a member-network may send or receive blind gifts from parties outside the member-network; and, parties outside any member network may exchange blind gifts, as well. In this embodiment, a business entity separate and apart from any membership network operates an independent blind gift Web site 24 on the World Wide Web which. This independent Web site would display the wares of many different gift vendors. It would be directly accessible through Giftors' and Giftees' Internet service providers (ISP's) 26 and 28 wherein such ISP's may or may not be content-providing membership networks such as America Online.

In the drawing figures, direct, pseudonymous communication between Giftor and Giftee occur through their ISP's 26 and 28 over the Internet. Such direct communications are identified herein and in the drawing figures with reference numeral 30. communications between the Giftor and the blind gift Web site 24, through Giftor's ISP, are identified with reference numeral 32. And, communications between the blind gift Web site 24 and the Giftee, through Giftee's ISP, are identified with reference numeral 34. Communications between the blind gift Web site and the vendors are identified with reference numeral 36.

The independent Web site 24 would function in two primary ways. In one, prospective Giftees in blind gift exchange transactions occur pre-register at the Web site as being willing to receive blind gifts. Such pre-registration would simply constitute addition of the Giftee's full, true name and mailing address to the Web site's database, along with each e-mail address in care of which the Giftee would permit gifts to be sent. (In this embodiment, participants' entire e-mail addresses serve as the pseudonyms.) For any prospective Giftee so registered, a Giftor may simply access the blind gift Web site via a personal computer, enter the Giftee's e-mail address, and then choose and pay for a gift to be delivered to the Giftee.

Alternatively, in a second mode of use wherein the Giftee is not pre-registered, a Giftor may simply access the blind gift Web site, choose a gift, and request that the chosen gift be sent to the person identified by a particular e-mail address. At this point, an e-mail message or an instant message would be generated by the Web site's software and sent to the Giftee, informing the Giftee that a blind gift attempt was being made, and asking that the Giftee confidentially reveal his or her full, true name and mailing address. The Giftee would need to be assured that the information would be kept confidential from the Giftor, and from all third parties. In the simplest version of the embodiment, the Giftee's only options might be to refuse to enter his or her name and address, or to comply. If the Giftee refused, the Giftor would be informed of that refusal. On the other hand, if the Giftee complied and entered the requisite information, the gift would be sent.

The practice of the inventive method through an independent Web site provides the same wide potential variety of different choices to the Giftor and Giftee regarding the method within a membership network. However, in the Web site-based embodiment, more of the choices, screening and communication will likely be carried out on an ad hoc basis. Add some will necessarily be. Thus, instead of the Giftor setting up a mandatory initial profile, all of the choices which go into making up that profile may, alternatively, be made on a per-use basis. Likewise, the Giftee, unless previously registered with the Web site, may be given the opportunity to make all of the subject matter and communication choices on a use-by-use basis.

As in the first embodiment, many options exists regarding billing and delivery. In one paradigm, the business entity hosting the Web site could stock inventory, bull the Giftor directly, and physically pack and shop the gift to the Giftee. In another paradigm, wherein the Web site-hosting entity is only electronically involved, Giftor's orders are sent along to manufacturers, distributors or retailers who carry out the packing and shipping, and who might also attend to the detail of billing the Giftor.

Whether operating through a member-network, or through an independent Web site, it is envisioned that the greatest potential gift variety and thus the most robust embodiment of the program will be achieved by providing, at each gift portal --i.e. on those pages of each vendor's Web site 38 where purchases can be made -- a blind gift button or link which takes the user directly to the blind gift program. Such an embodiment is illustrated in FIG. 4. Communications between the Giftor and a vendor's links between vendors' Web sites 38 and blind gift button or link associated with an on-screen product would immediately launch software ready to collect from a prospective Giftor the pseudonym and/or e-mail address of the prospective Giftee. Functions carrying out the financial portion of the transaction would be launched during that process, as well.

It is also envisioned that in all embodiments of the inventive method and system the participants, i.e., the Giftor or Giftee, will have control over whether to maintain the confidentiality of, or to reveal, their true identify information.

It is yet further envisioned that a preferred embodiment of the method and system will also be fully functional whether either one or both of the participating parties is in possession of and able to supply true name and mailing address information of the other party. This, for example, if the Giftor knows the full mailing address of the Giftee, the software carrying out the inventive method and system should be flexible enough to skip part or all of the database lookup function, and proceed directly to shipping.

The foregoing detailed disclosure of the inventive method and system is considered as only illustrative of the preferred embodiment of, and not a limitation upon the scope of, the invention. Those skilled in the art will envision many other possible variations of the method and structure disclosed herein that nevertheless fall with the scope of the following claims. For example, although on-line and Internet-based modes of practicing the invention are set forth herein, the inventive concept is not limited to those modes or to computer-based systems. For example, it is envisioned that the environment where people may communicate and get to know each other while using a pseudonym or other indicia as their identity, such as on telephone chat lines, or in pen-pal networks, or the like, a blind gift registry could operate to catalogue pseudonyms and corresponding true, full name and mailing address information. Then, any time a Giftor desired to send a blind gift to a Giftee known only by a pseudonym, that could be accomplished through the blind gift registry in accordance with the method herein. And, shipping could be carri4d out by vendors associated with the blind gift registry. May of the optional features suggested hereinabove may also be employed in such a non-computerized blind gift program. For example, upon the registry of the vendor receiving the gift request from the Giftor, the prospective Giftee could be contacted by telephone and asked if the gift would be accepted. Responses back to the Giftor, if desired, could be provided-for much in the same manner as would be possible through a computer-based program.

And, alternative uses for this inventive method and system may later be realized. Accordingly, the scope of the invention should be determined with reference to the appended claims, and not by the examples which have herein been given.

Claims

1.A method enabling a first party to send a gift to a second party, the method comprising the steps of:
receiving a request over the Internet from said first party for said gift to be sent to said second party;
obtaining over the Internet from said first party a pseudonym of said second party;
securing over the Internet a non-pseudonymous name and address associated with the second party's pseudonym; and
producing computer output enabling said gift to be sent to said second party while said non-pseudonymous name is not revealed to said first party.

2. The method of claim 1, further including the step of issuing an order that said gift be sent to said second party's non-pseudonymous name and address.

3.The method of claim 1, wherein said step of securing a non-pseudonymous name and address associated with said second party's pseudonym is carried out by looking up said second party's pseudonym in a database.

4.The method of claim 1, wherein said step of securing a non-pseudonymous name and address associated with said second party's pseudonym is carried out by contacting said second party and requesting revelation of said second party's non-pseudonymous name and address.

5. The method of claim 1, further including the steps of, prior to the step of receiving said request:
giving said second party an opportunity to choose whether said second party will accept, or will not accept, attempted gifts addressed only to said second party's pseudonym; and,
storing said second party's choice, if made, in said database in association with said second party's pseudonym or name and address.

6. The method of claim 5, further including the step of, upon electronically obtaining said second party's pseudonym from said first party, checking said second party's stored choice.

7. The method of claim 5, further including the step of, if said second party's choice is to accept gifts addressed only to said second party's pseudonym, issuing an order that said gift identified by said first party be sent to said second party's non-pseudonymous name and address,
8. The method of claim 5, further including the step of, if said second party's choice is not to accept gifts addressed only to said second party's pseudonym, or if said second party made no choice, initiating electronically informing said first party that said gift identified by said first party was not sent to said second party's non-pseudonymous name and address.

8. 9.The method of claim 1, further including the step of electronically informing said first party that said second party has not chosen to accept gift addressed only to said second party's pseudonym.

9. 10. The method of claim 1, further including the step of electronically communicating to a third party an order that said gift be sent.

10. 11. The method of claim 1, further including the step of electronically giving said first party an opportunity to reveal true identity information about said first party's self.

11. 12. The method of claim 1, further including the step of electronically giving said second party an opportunity to reveal true identity information about said second party's self.

12. 13. The method of claim 1, further including the step of electronically charging a fee to said first party.

13. 14. The method of claim 13, wherein said fee is charged electronically to a charge card of said first party.

14. 15.The method of claim 13, further including the step of confirming receipt of said order that said gift be sent, before electronically charging said fee to said first party.

15. 16. The method of claim 1, further including the step of electronically charging a first fee to said first party.

16. 17. The method of claim 16, further including the step of electronically charging a second fee to said first party, wherein said second fee is related to the value of said gift.

17. 18. The method of claim 1, further including the step of electronically charging a fee to said second party.

18. 19. A system enabling a first party to send a gift to a second party, comprising:
computers respectively for said parties; and
a web site, operably connected to said computers, enabling said first party to send said gift to said second party by a pseudonym of said second party without said web site revealing a non-pseudonymous name to said first party.

19. 20. The system of claim 19, wherein said web site enables charging a fee to said first party.

20. 21. The system of claim 19, wherein said web site enables said second party to refuse said gift from said first party.

21. 22. The system of claim 19, wherein said web site enables said second party to refuse said gift from said first party.

22. 23. The system of claim 19, wherein said web site enables said second party to refuse a gift from said first party if said first party is not identified by a true name.

23. 24. The system of claim 19, wherein said web site enables second party to refuse a gift from said first party if said first party is identified by a particular pseudonym or true name.

24. 25. The system of claim 19, wherein said web site enables said second party to refuse a gift from said first party if said gift is of a particular product-type.

25. 26. The system of claim 19, wherein said web site enables said second party to respond to said first party after delivery of a gift sent to said second party by said first party.

26. 27. The system of claim 19, wherein said web site enables said second party to respond to said first party after refusal of an attempted gift to said second party by said first party.

27. 28. The system of claim 19, wherein said web site enables said first party to reveal or maintain confidentiality of true identity information of said first party.

28. 29. The system of claim 19, wherein said web site enables said second party to reveal or maintain confidentiality of said second party's true identity information.

29. 30.The method of claim 1, wherein said gift is only sent responsive to a message received from the second party.

30. 31.The method of claim 1, wherein said gift is only sent responsive to an acceptance communication electronically received from the second party.

31. 32.The method of claim 1, wherein said gift is only sent responsive to a signal received over the Internet from the second party.

32. 33.The method of any one of claims 1-18 or 30-32, further including the step of:
providing a web site for carrying out at least one of said steps.
